(19) United States
(12) Patent Application Publication
(10) Pub. No.: US 2011/0238556 A1
(43) Pub. Date: Sep. 29, 2011

(54) SYSTEM FOR MATCHING INTERNAL ORDERS

(76) Inventors: Borys Harmaty, New York, NY (US); Bijoy Paul, New York, NY (US); Mark Ficke, New York, NY (US)

(21) Appl. No.: 13/041,353

(22) Filed: Mar. 4, 2011

Related U.S. Application Data
(60) Provisional application No. 61/310,686, filed on Mar. 4, 2010.

(51) Int. Cl. G06Q 40/00

(52) U.S. Cl. 705/37

(57) ABSTRACT

A processor coupled to a memory may receive a first trading order from a first trading participant associated in the at least one database with a first entity, the first trading order comprising a price. The processor may, after receiving the first trading order, receive a second trading order from a second trading participant associated in the at least one memory with a second entity different from the first entity, the second trading order comprising the price. The processor may ordering the first trading order ahead of the second trading order in a trading order queue at the price. After receiving the first and second trading orders and while the first trading order is available for execution, the processor may receive a third trading order from a third trading participant associated with the second entity in the at least one memory, the third trading order being contra to the first and second trading orders at the same price. The processor may determining that the second and third trading orders are associated with the same entity in the database. The processor may, based at least in part on determining that the second and third trading orders are associated with the same entity, match at least a portion of the second trading order with at least a portion of the third trading order. The processor may cause the at least portion of the second trading order to be executed against the at least portion of the third trading order.

### RELATED APPLICATIONS

This application claims the benefit of Provisional Application Ser. No. 61/310,686, filed Mar. 4, 2010, which is incorporated by reference herein in its entirety.

### FIELD OF INVENTION

This invention relates to systems and methods for matching and executing trading orders provided by a plurality of trading participants.

### BACKGROUND

Traditional electronic trading systems receive bids and offers for financial products from a plurality of trading parties. Some systems use a “first in first out” (FIFO) rule or preference in executing orders, such that the first order received on a particular side of a transaction at a particular price is executed before a later-received order at the same price on the same side of the transaction. One exemplary system that matches orders at least in part based on the order's time priority is the system described in U.S. Pat. No. 5,905,974 to Fraser et al, the disclosure of which is incorporated by reference herein in its entirety.

### SUMMARY

Various methods and systems are provided for matching and executing orders from a plurality of trading participants. Orders may be received______

### BRIEF DESCRIPTION OF THE FIGURES

FIG. 1 depicts a system according to at least one embodiment of the systems disclosed herein;

FIG. 2 depicts a flow diagram according to at least one embodiment of the methods disclosed herein.

FIG. 3 depicts a flow diagram according to at least one embodiment of the methods disclosed herein.

FIG. 4 depicts a flow diagram according to at least one embodiment of the methods disclosed herein.

### DETAILED DESCRIPTION

The following sections I-XI provide a guide to interpreting the present application.

### I. Terms

The term “product” means any machine, manufacture and/or composition of matter, unless expressly specified otherwise.

The term “product” means a machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed, and does not imply that numerical methods must be used, and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. §1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation by Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### DETAILED DESCRIPTION OF EXEMPLARY EMBODIMENTS

According to various embodiments, an apparatus comprises at least one processor and at least one memory that stores instructions which, when executed by the processor, direct the at least one processor to perform various steps. The processor may receive a first trading order from a first trading participant associated in the at least one database with a first entity, the first trading order comprising a price. The processor may, after receiving the first trading order, receive a second trading order from a second trading participant associated in the at least one memory with a second entity different from the first entity, the second trading order comprising the price. The processor may ordering the first trading order ahead of the second trading order in a trading order queue at the price. After receiving the first and second trading orders and while the first trading order is available for execution, the processor may receive a third trading order from a third trading participant associated with the second entity in the at least one memory, the third trading order being contra to the first and second trading orders at the same price. The processor may determining that the second and third trading orders are associated with the same entity in the database. The processor may, based at least in part on determining that the second and third trading orders are associated with the same entity, match at least a portion of the second trading order with at least a portion of the third trading order. The processor may cause the at least portion of the second trading order to be executed against the at least portion of the third trading order.

In some embodiments, the price may comprise a best price in the market.

In some embodiments, the first order may comprise a bid to purchase a first quantity of a financial instrument at the price. The second order may comprise a bid to purchase a second quantity of a financial instrument at the price. And the third order may comprise a hit, the hit comprising an order to execute a transaction against at least a portion of bid quantity available at the price.

In some embodiments, the first order comprises an offer to sell a first quantity of a financial instrument at the price, the second order comprises an offer sell a second quantity of a financial instrument at the price, and the third order comprises a take. The take comprising an order to execute a transaction against at least a portion of offer quantity available at the price.

In some embodiments, method further comprises receiving a fourth trading order from a fourth trading participant associated with a third entity that is not associated with the first or second entities in the at least one memory, the fourth trading order being contra to at least an available portion of the first trading order and at least an available portion of the second trading order at the same price; determining that the fourth trading order is contra to the first and second trading orders; and matching at least a portion of the fourth trading order with at least a portion of the first trading order before any matching of any portion of the fourth trading order with any portion of the second trading order.

In some embodiments, the method further comprises causing the first and second orders to be ordered in a trading queue according to a time priority.

In some embodiments, at least portion of the second trading order comprises all of the quantity of the second trading order.

In some embodiments, the at least portion of the third trading order comprises all of the quantity of the third trading order.

In some embodiments, the act of determining that the second and third trading orders are associated with the same entity in the database comprises determining an order identifier associated with the second order.

In some embodiments, method further comprises causing the executed portion of the second trading order and the executed portion of the third trading order to be removed from the trading order queue; and sending a message to a plurality of traders that the executed portion of the second trading order was cancelled.

In some embodiments, the method further comprises causing the executed portion of the second trading order and the executed portion of the third trading order to be removed from the trading order queue; and sending a message to a plurality of traders that the executed portion of the second trading order was executed at the price.

In some embodiments, the method further comprises causing the executed portion of the second trading order and the executed portion of the third trading order to be removed from the trading order queue; after causing the executed portion of the second trading order and the executed portion of the third trading order to be removed from the trading order queue, determining that a condition has been satisfied; and based on determining that the condition has been satisfied, sending a message to a plurality of traders that the executed portion of the second trading order was executed at the price.

In some embodiments, the act of determining that the condition has been satisfied comprises determining that a predetermined period of time has passed after causing the at least portion of the second trading order to be executed against the at least portion of the third trading order.

In some embodiments, the apparatus of claim 1, in which the act of determining that the condition has been satisfied comprises determining that a the financial instrument has been executed at a new price that is different from the price after causing the at least portion of the second trading order to be executed against the at least portion of the third trading order.

In some embodiments, the apparatus of claim 1, in which the act of ordering the first trading order ahead of the second trading order in a trading order queue at the price comprises determining, for each of the first and second trading orders, a priority in a trading order queue based on a time at which each order was received.

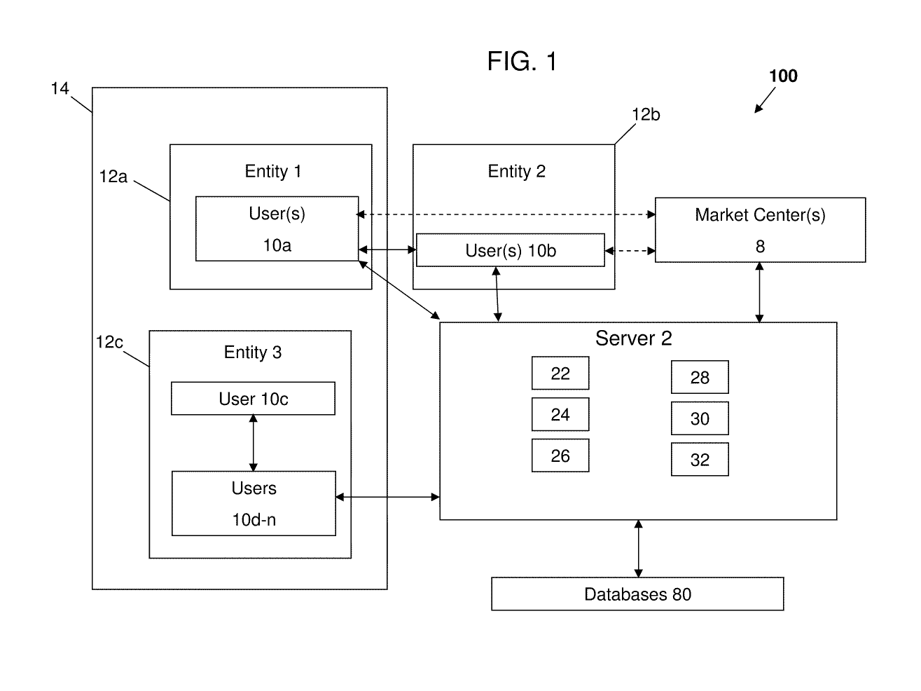

FIG. 1. Exemplary System

Some embodiments of the present invention provide systems and methods for providing an art exchange.

The system 100 may comprise one or more servers 2 coupled to one or more databases 80, one or more data providers 8a-8n, one or more end users 10a-10n, and one or more agents 12. The data providers 8a-8n, users 10, agents 12, and server 2 may each communicate with each other. Users 10 may also communicate with other users 10, e.g., concerning one or more orders, market information, or other financial-related information.

Server 2 may comprise one or more processors, computers, computer systems, computer networks, and or computer databases. Server 2 may comprise modules 18-64. Server 2 may also comprise one or more databases, such as databases 80. Server 2 may communicate with users 10, data providers 8, and agents 12. For instance, server 2 may communicate with a user 10 computer, such as a browser of a user computer, e.g., over the internet. In some embodiments, server 2 may match and execute orders from a plurality of users 10. In some embodiments, server 2 may comprise a market center that manages, matches, and executes orders submitted by users 10.

An order may comprise an offer to buy or sell a quantity of a financial instrument, e.g., as known in the art. An order may specify a buy side or a sell side, a financial instrument, a quantity of the financial instrument, and a price. An order may comprise a bid, an offer, a hit, or a lift (or take). In some embodiments, an order may comprise a composite order made up of a plurality of orders. Orders may also define special instructions concerning the order, e.g., depending on the circumstances. For example, an order from one user 10a associated with an entity 12a may specify instructions concerning execution depending on whether a counter-order is present from another user 10b of the same entity 12a. For example, an order may specify a variable price based on whether a counter-order is present from the same entity.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Market centers 8 may comprise a one or more market centers 8 that manage, match, and execute user orders. In some embodiments, server 2 may send and/or re-route one or more orders (or portions thereof) to one or more other market centers 8. Market centers 8 may also comprise any processor, information service, or other entity that publishes or otherwise provides information concerning one or more orders to server 2 or users 10. For example, a market center 8 may comprise a data feed, stock price provider (e.g., entity that provides real-time price updates and stock ticker information), data service, website, or other source of information relevant to a financial instrument or market. The information may comprise information about one or more orders. In some embodiments, the data may include information that may be relevant to a current market price of a financial instrument, e.g., a financial instrument for which orders are submitted to server 2. In some embodiments, the data may include information that may be of interest to a user 10 or server.

Users 10a-10n may comprise one or more traders, which may comprise one or more humans or other trading entities. Users 10 may interact with server 2, market center 8, and/or other users 10 to communicate orders and other financial-related information, e.g., as described herein or as known in the art. As used in this application, users 10a-10n may also refer to a user's interface to other system 100 components (like server 2), such as a user's PDA or computer or a program running on a user's computer such as a computer web browser like Internet Explorer™, which may communicate with market centers 8, agents 12, and/or server 2.

Market center 8 may provide information in real time, as information first becomes available to the general public, or at another time. Data may be provided at a variety of different timings. In some embodiments, data may be provided in periodically, continuously, or continually, e.g., via a data feed (e.g., a stream of data that includes real time updates of market information).

Entity 12 (e.g., entities 12a-12c) may comprise a set of users 10. Entity 12 may comprise, for example, a company, a legal entity, a brand, a set of traders identified on a list (e.g., a list of traders associated with a particular entity). For example, entity 12 may comprise a company employing trading users, or a trading desk of the company, or a legal entity, or a specific subsidiary or affiliate of the legal entity, or another entity. Entity 12 may also comprise a set of traders satisfying one or more criteria (e.g., a group of traders satisfying a particular volume threshold requirement in a particular period of time), a set of traders known to trade a particular type of financial instrument, etc. It should be appreciated that a set of users 10 for a particular entity 12 may be identified according to any criteria that may characterize a user or a characteristic associated with the user 10, such as features related to the user's trading behavior.

In some embodiments, users 10 may be associated with one or more entities 12, e.g., in a database 80.

Entity group 14 may comprise one or more entities 12, e.g., a set of entities 12. For example, a bank franchise or conglomerate may define a group 14 of individual bank franchise entities 12 or conglomerated entities 12, each of which may have one or more users associated with them.

Thus, a user 10 may be a part of a plurality of different entities 12 and entity groups 14.

Each user's various identifications/associations may be ranked, e.g., in order of preference or “priority” for matching. For example, a user may be associated with a number of different entities 12. For example, a user may be employed by one entity 12a, affiliated with another entity 12b, and the affiliate may be affiliated with another entity 12c. The user 10 may wish to execute “internal orders” (as discussed herein) first against orders from users associated with entity 12a, and then against orders from users associated with entity 12b, and then against orders from users 10 associated with entity 12c. Alternately, the user may have no preference between entities 12b and 12c.

The server 2 may comprise a computer, server, hub, central processor, or other entity in a network, or other processor. The server 2 may comprise input and output devices for communicating with other various system 100 elements. In some embodiments, the server 2 may comprise an art exchange.

In some embodiments, the server 2 may be comprised in an end user's computer 10, e.g., as a toolbar in a user's web browser or another program running on the user's computer.

As shown in FIG. 1, the server 2 may comprise a plurality of modules, such as modules 22-34. Each module may comprise a processor as well as input and output devices for communicating with other modules, databases, and other system elements.

User interface module 22 may communicate with users. User interface module may communicate with users so that users can set up an account, log in to an account; prompt a user to submit preferences concerning one or more works of art; receive user preferences and selections concerning one or more works of art; communicate with users to provide information regarding one or more works of art.

User interface module 22 may cause information to be output to a user, e.g., at a user output device such as a display device (e.g., a display device at a user terminal), a speaker. The information outputted to a user may be related to a user account, one or more works of art, preferences, and other information described herein. User interface module may communicate the information electronically, e.g., via networked communication such as the internet (e.g., in an email or webpage), telecommunication service, etc. In some embodiments, user interface module 22 may comprise input devices for users to information about one or more works of art, such as a request for one or more specific works of art, rating information about one or more works of art, pricing information (e.g., a bid or offer concerning one or more works of art or one or more shares or other interests in an ETF or other art ownership vehicle), and other information.

User identification module 24 may receive, identify, or determine one or more entities 12 or groups 14 associated with one or more users 10. In some embodiments, user identification information about one or more users may be stored in at least one database.

Order information module 26 may determine information associated with one or more orders submitted by one or more traders 10. For example, order information module may determine a value of the works of art in an art exchange and determine a value of an ETF that is associated with (e.g., that is intended to mirror or track a value of) an art exchange.

Transaction disclosure module 28 may disclose information about executed transactions to users. For example, transaction disclosure module may disclose that executed transactions have been cancelled. Module 28 may delay disclosure of the transaction details, such as the existence of an actual transaction.

Priority module 30 may determine information about the time priority of one or more orders, e.g., orders in a queue at a particular price.

Market Center module 32 may send unexecuted portions of an order, e.g., that were not matched to any order, to a different market center.

Databases

As shown in FIG. 1, a database 80 may be coupled to the server 2. The database 80 may comprise a plurality of databases as described below. Databases 80 may store information about users, elements, and other information.

The modules may function separately or in various combinations. While the modules are shown within a single server, the modules may also operate among several servers. The modules may communicate with a plurality of databases, which may also function collectively or separately.

The modules of server 2 may store, access and otherwise interact with various sources of data, including external data, databases and other inputs.

An Exemplary Method

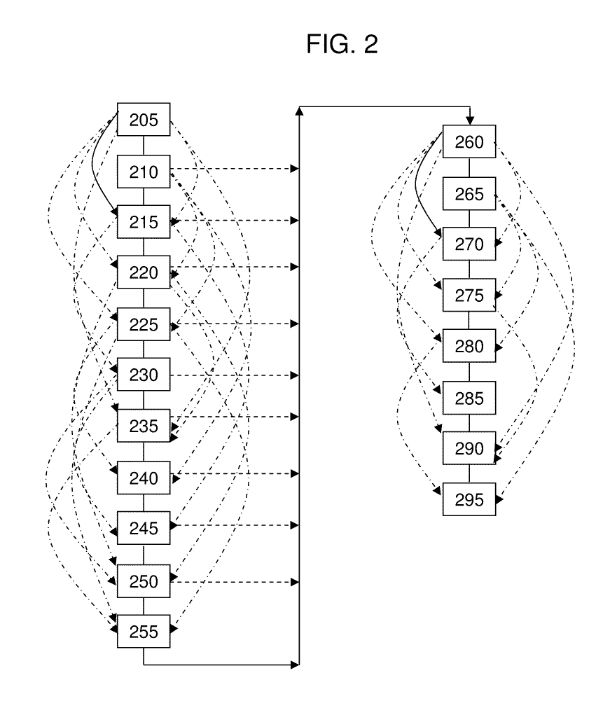

FIG. 2 depicts a flow diagram according to at least one embodiment of the methods disclosed herein.

It should be understood that each function(s) described for each block may be performed using a module capable of performing that function, e.g., according to methods described for each module above. It should also be appreciated that the acts described in these blocks may be performed in any order (including but not limited to the exemplary orderings shown on the diagram), and not all blocks need be performed.

In block 205, one or more users may be associated with one or more entities. For example, a first plurality of users 12 may be associated in database 80 with one entity 12a, a second plurality of users 12 may be associated with a second entity 12b, a third plurality of users 12 may be associated with a third entity 12c. One or more of the users 12 may be associated with more than one entity (e.g., 12a and 12b). In some embodiments, unique identifiers associated with each trader 10 may be associated in the database 80 with unique identifiers associated with the corresponding entity 12.

In block 210, one or more entities may be associated, e.g., in database 80, with one or more groups 14. For each entity 12 associated with a group 14, the users 10 associated with that entity may also be associated with the group 14. Similarly, one or more users may be directly associated with one or more entities and groups. In some embodiments, unique identifiers associated with each entity 12 may be associated in the database 80 with unique identifiers associated with the corresponding group 14. Similarly, unique identifiers associated with each trader 10 may be associated in the database 80 with unique identifiers associated with a corresponding entity 12.

In block 215, a first user 10a associated with entity 12a may submit a first trading order, e.g., a bid to purchase a designated quantity of a particular financial instrument for a designated price. The order could also be a sell order.

In block 220, the first order may be placed in a queue, e.g., a queue of orders for a specific financial instrument at a specific price on a specific side (buy side or sell side). The queue may already have other orders at the same price (e.g., other orders to purchase the same or different quantities of the financial instrument). The orders in the queue may be ordered according to time priority, e.g., based on the time at which the order was received by server 2 (or submitted by user 10). The system may be configured to match and execute orders by time priority according to the principle of “first in first out” (FIFO), such that the earliest orders at a specific price for the financial instrument receive a higher time priority, which tends to cause those orders to be executed before, orders for the same instrument at the same price that are received later, and thus have a lower time priority. Time priority may be based on the relative order in which the trading orders are received (as opposed to the exact time on a clock at which they are received).

In block 225, information about the first order may be transmitted to a plurality of users 12, e.g., as known in the art.

In block 230, the information about the first order may be displayed at a plurality of user trader terminals, e.g., as known in the art. For example, a user trader terminal may display that the quantity of the financial instrument is available to be sold at the designated price. If quantity was already available to be sold at the price, the quantity displayed may be updated to add the additional quantity of the first order.

In block 235, a second user 10b associated with a second entity 12b may submit a second trading order, e.g., a bid to purchase a designated quantity of the particular financial instrument for the designated price—e.g., the same financial instrument and same price as the first order on the same side of the transaction. (The order could also be a sell order.)

In block 240, the second order may be placed in the same queue according to time priority, e.g., at a lower time priority than the earlier-received order from the first user 10a. Information about the second order may be transmitted to a plurality of users 10 and displayed on corresponding trader interfaces, e.g., as known in the art.

In block 245, a third user 10c associated with the second entity 12a may submit a third trading order that is contra to the first and second orders. The third order may be for the same financial instrument at the same price on the opposite side of the transaction. For example, the third order may comprise an order to sell a designated quantity of the financial instrument for the price. The third order may be capable of satisfying at least a portion of the first order, second order, and any other order in their queue. In some embodiments, information about the third order may not be transmitted to users 10. In other embodiments, information about the third order may be transmitted to a plurality of users 10 and displayed on corresponding trader interfaces, e.g., as known in the art.

In block 250, server 2 may determine that the third order is contra to the first and second orders (as well as other orders in their queue).

In block 255, server 2 may determine that the third order and the second order are associated with the same entity 12b. The server 2 may also determine that the second order has the highest priority in the queue of the subset of orders in the queue that are associated with entity 12b, e.g., if there is more than one order in the queue associated with entity 12b.

In block 260, server 2 may match at least a portion of the quantity of the third order with a matching at least portion of the quantity of the second order. The matching may be based on a determination that the third order and second order are associated with the same entity. The matching may also be based on a determination that the second order has the highest time priority of the orders in the queue associated with the second entity 12b. The portion of the orders matched may depend on their respective quantities. For example, if the third order comprises 300 and the second order comprises 100, the server 2 may match 100 of the 300 quantity in the third order with the 100 quantity of the second order. In this example, 200 of the third order may be unmatched at this point. This matching may occur before any portion of the third order is matched with any portion of the first order, which has a higher time priority than the second order.

In block 265, the server 2 may execute the at least portion of the third order against the at least portion of the second order. This execution may occur before executing any portion of the third order with any portion of the first order, which has a higher time priority than the second order. It will be appreciated that in this way, an order may be matched and executed “out of turn” (as compared to the order's time priority in a FIFO system) against another order if both orders are associated with the same entity 12. In other words, an order associated with an entity 12n may be matched with other “internal” orders (orders associated with the same entity 12s) before matching the orders based on time priority. Put another way, the server 2 may preference “internal” orders over “non-internal” orders of higher time priority.

In block 270, in some embodiments, the server 2 may remove the matched and executed portion of the second order from the queue. This may occur after the match or after the execution. The server 2 may also remove any matched and/or executed portion of the third order, and/or other orders (or portions thereof) that are executed, cancelled, or otherwise unavailable, e.g., as known in the art.

In block 275, the server 2 may communicate (e.g., electronically transmit) information based on the matching or execution to a plurality of users 10 (e.g., trading participants on the trading system 100). The information may be information that a transaction occurred at a specific price in a specific amount at a specific time. In some embodiments, the communication may be information that the matched portion of the order has been cancelled. For example, the server 2 may transmit a record of the transaction indicating one or more or all of the price, quantity, financial instrument, and time of execution of the transaction involving the second and third orders. This information may be communicated in real time, or it may be delayed, e.g., for a predetermined period of time (such as 1 second, 10 seconds, 1 minute, 2 minutes, five minutes, 1 hour, 2 hours, five hours, or end of trading day), or until certain criteria are satisfied (such as a change in price of the financial instrument or one or more orders for the instrument, a change in the best price of the instrument, the occurrence of a trade of the financial instrument at a different price, or a price that is different from the second and third order's price by a predetermined amount such as 0.0001 dollars or 1 dollar).

In some embodiments, the server 2 may delay disclosure of the matching or execution to other traders so that information about the transaction does not impact the market like a typical completed trade might. For example, traders may react different to information that a trade took place at a particular price than they would react to information that various orders at a particular price were cancelled. (Often, a hit or lift against a pending order may cause a price to go down (or up), whereas a cancellation will have little or no effect on other traders' behavior.)

In block 280, user 10 terminals may display information based on the information received based on the matching and/or execution. For example, if the matched portion of the order(s) is indicated to be cancelled, then the user terminals 10 may be updated to reflect that such orders or quantity was cancelled. In some embodiments, information about an executed transaction may be displayed.

In block 285, the server 2 may match (and/or execute) a remaining portion of the third order with another order in the queue that is associated with entity 12b. For example, a remaining portion of the third order may be matched with another order in the queue that is associated with entity 12b, but is lower in time priority than the second order. In some embodiments, the various matching steps described herein may occur substantially simultaneously. For example, server 2 may match (and execute) 100 of the remaining 200 of the third order against a fourth order for 100 at the same price that is associated with entity 12b, which would leave 100 still remaining in the third order.

In block 290, the server 2 may match (and/or execute) a remaining portion of the third order with another order in the queue, e.g., a fourth order. The fourth order may be lower in time priority than the first order, and thus be matched (and executed) “out of turn.” The fourth order may be associated with entity 12b. In some embodiments, the fourth order may not be associated with entity 12b but instead associated with another entity, e.g., entity 12x, that is also associated with the third order. For example, the third order may be associated with more than one entity, such as entities 12b and 12x. In some embodiments, the server 2 may match the third order first with all orders from 12b, and then all orders from 12x. For example, the order may comprise instructions to favor “internal” orders associated with 12b ahead of “internal” orders associated with 12x. In another embodiment, both entities 12b and 12x may have equal “entity priority”, but the orders may simply be matched against the third order in their relative order of time priority.

In block 295, the server 2 may communicate information about such matching or execution (or alleged “cancellation”) to a plurality of users, e.g., in real time or on a delayed basis, as discussed herein.

The server 2 may match (and/or execute) any remaining portion of the third order (e.g., after matching against the second and fourth orders) according to the remaining orders in the queue according to standard, FIFO-based time priority. E.g., the server 2 may match any remaining portion of the third order against the first order. Any remaining portion of the third order after these matchings may be matched (and executed) against the next order (in time priority) in the queue.

Additional Exemplary Systems and Methods

As described below, exemplary systems such as BGC's eSpeed trading platform may implement features of the invention on trading orders for U.S. Treasuries (“UST”), as an exemplary embodiment. Server 2 may comprise eSpeed's platform, as adapted to operate in conjunction with the features described herein.

In some embodiments, to avoid market manipulation, the server 2 may not match orders from the same user. Client developed applications may aggregate orders originating from different individuals and strategies and submit them with a single user. Complex logic may then be appropriate or required to handle situations when a client is simultaneously a buyer and a seller, often resulting in pulling orders from the system.

In some embodiments, the system allows users 10 within the same entity 12 to trade with one another when their orders match, e.g., under standard matching protocols. However, many entities 12 such as company clients have developed applications to maximize matching their internal orders. These applications may require similar logic when users within their legal entity are simultaneously buyers and sellers, again often resulting in pulling orders from the system. This may be referred to as internalization of order flow.

In various embodiments of the invention, a trading system (such as the eSpeed system, as used herein for exemplary purposes) may be modified to match orders whose users belong to a pre-defined set prior to matching them against the entire market. In some embodiments, this action may be equivalent to a Customer entity 12 matching their own orders against each other just prior to sending them over to the trading system (such as eSpeed), sometimes referred to herein as “internal matching”. In some embodiments, internal matching may be limited to participants which certify their application processing. Internal matching may permit users to transact off-exchange within themselves (e.g., within the entity 12) and assist users of the same group with internalizing their order flow.
In some embodiments, opposing orders from the same user may match without any indication to other users. In some embodiments, same user trades may not flash and related volume may be published with an “off-exchange” indicator.
In some embodiments, groups may be defined as a collection of eSpeed authorized users. In some embodiments, groups are not to be restricted to the current LE structure. In some embodiments, groups can be defined either as a collection of eSpeed userids or Sourceids. In some embodiments, the SourceID field may be used in implementations where an Aggregator at a Customer submits all their orders using a few eSpeed userids.
In some embodiments, order matching amongst users of a group may be maximized In some embodiments, trades amongst users of the group may not flash and related volume may be published with an “off-exchange” indicator whenever a user's stack position was modified to accommodate the same firm match.
In some embodiments, same user 10 and same entity 12 or group 14 trades may be reported to the user 10 and to their respective tradefeed as they are today. In some embodiments, they may not be settled via GSCC. In some embodiments, the tradefeed reporting may be for Customer entity's 12 internal booking and risk management purposes only.
In some embodiments, additional (or reduced) commission revenue from an Internal Match, if any, may be determined by any of a variety of methods. For example, commissions for internal matches may trigger a reduced (or enhanced) fee as compared to a non-internal transaction.
In some embodiments, standard message formats and messages semantics may be used as part of this modification to insure compatibility with existing client developed applications. In some embodiments, specific changes to the API and confirms are noted below.
In some embodiments, when multiple users 10 of the same entity 12 or group 14 are available in the resting order book, the system may match the aggressive user with other users within the group in price/time (FIFO) order.
In some embodiments, whenever an internal match occurs, the system may attempt to preserve the overall group's best position in the order queue, by reassigning the remaining firm orders to the remaining users based on the original time of the order submission. In some embodiments, the reassignment logic may ensure that the displayed quantity in the order stack never exceeds the original displayed quantity (before the internal match transaction) and no new entries are created in the middle of the stack.

Same Entity Internal Matching

In some embodiments, the current UST system allows users from the same firm to trade with one another whenever their requests cross in the system and prohibits the same user from trading with themselves. In some embodiments, it may be desired to preference match amongst users of the same legal entity and from the same user prior to matching orders from others in the order book. In some embodiments, one objective of this modification may be to eliminate the need for applications to think about whether their order would match with themselves or other users within their firm that may have opposing order flow.

In some embodiments, incoming requests enabled for Internal Matching (IM) may first match resting orders from themselves and users within their group. In some embodiments, residual volume from the incoming request may then continue to match with remaining resting orders based on the standard system matching protocols.

In some embodiments, when IM is enabled incoming requests may match, e.g., in the following sequence: Group 1, Group 2, Others
Group—Match with resting orders from users within the defined group based on their position in the order book.
Others—Match with remaining resting orders based on their position in the order book.

In some embodiments, an exemplary pre-specified ordering for a particular customer may comprise the following: First Priority Entity, Second Priority Entity, Third Priority Entity, First Priority Group, Fourth Priority Entity, and then match with other orders based on their position in the order book (e.g., based on time priority).

In some embodiments, if preferencing the resting order book would not change the matching results for the incoming order, then the order book may be matched using standard system matching protocols. (I.e., if the incoming volume would be satisfied by simply matching with the resting order book and all same firm users would match then there may be no benefit to changing the match sequence of the resting order book, in some embodiments.)

In some embodiments, Internal Matching may operate as follows:
Some firms have their users and businesses split amongst multiple Child Legal Entities which refer back to a single Parent LE. IM may be implemented to operate amongst users within a group of defined users across multiple LEs. This may afford the most flexibility during implementation.
In some embodiments, volume associated with an IM match, when a non-firm user is skipped to accommodate the preferred match, may be published using standard set of trade price and trade size fields. In some embodiments, however, a set of volume-type fields may be introduced that may distinguish the volume as an off-exchange volume. In some embodiments, when an IM match does not skip any resting orders then the volume may be published with the volume type indicator set to “on-exchange.” In some embodiments, a skipped IM match may not start a trade state and therefore may not “flash” the trade in the Gui.
In some embodiments, trades solely amongst the same group may be marked off-exchange unless the first resting market in the order book is from the same group. In some embodiments, in this situation, a trade may begin to flash however the on-exchange size traded may be limited to that of the first resting market.
In some embodiments, trade requests through the order book, may IM match with users within the same group at each price level down to the worst price. In some embodiments, spill over size may then cause a normal TTS transaction and enter a trade state.
In some embodiments, IM transactions and their associated volumes may be flagged appropriately for internal reporting and to assist the help desk track user trade queries.
In some embodiments, where possible IM may attempt to preserve the groups best stack position by reducing size from the newest order amongst all the group's orders.

For example: Assume 3 users (A, B, C) from the same group are in the order book at the 2nd (A), 9th (B) and 12th (C) position each for size 10. If a GM for size 10 occurs from a fourth user of the group, the incoming order may match with the 10 posted from user A. However, when reducing the size from the order book, the system may eliminate the size associated from user C in the 12th position to preserve the position of the original order from A and B. As part of the transaction, the system may reassign ownership of the 2nd position to B and the 9th to C. Reassignment of the resting orders may be accomplished based on the FIFO position amongst the remaining group users in the order book.
In some embodiments, if there is spill-over size, then the transition between the IM and non-IM phase of the match may be marked by a market data update. In some embodiments, this update may send out the modified trade size, trade price and the new trade type fields and show the reduced sizes in the passive books. In some embodiments, the stack may also show reduced order sizes and possible bottom to top shifts of existing queued orders. Exemplary Reporting Requirements

In some embodiments, in addition to reporting trade sizes with the new trade type designator field, confirms and executions may also carry a new type designator that may distinguish it as an off-exchange match. In some embodiments, EIS may filter these trades in its reporting as well.

Other requirements are being developed with the help of customers and first adopters.

Exemplary Other Requirements

Priority

In some embodiments, prior to implementing IM, the legacy eSpeed Priority User privileges may be disabled. In some embodiments, the Trading System software release of IM may totally disable Priority User functions when the IM switch is turned on.

Pre-Executions

In some embodiments, the legacy eSpeed Trading System also supports Pre-Executions. In some embodiments, this condition may arise when an order cannot be matched immediately and instead of queuing it, it may be pre-matched conditionally. In some embodiments, a message indicating that the order may be matched at the specified price or better may be sent immediately, followed by the standard execution messages at a subsequent time. In some embodiments, support for Pre-Executions may be totally removed from the Trading System release that implements IM.

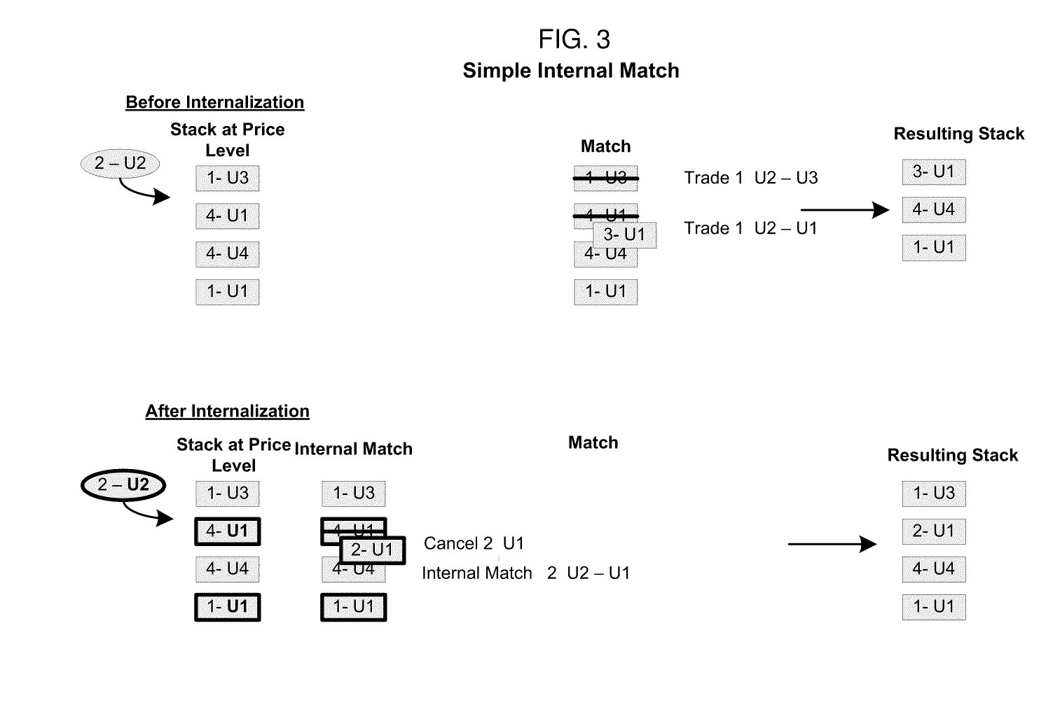

FIGS. 3, 4, and 5 show exemplary flow charts according to various embodiments of the invention.

The top of FIG. 3 shows a matching according to traditional time priority rules, wherein orders at the top of the stack are executed first. The bottom of FIG. 3 shows a matching where user 2 and user 1 are associated with the same entity. Here, the system executes user 2's order first against user 1's order of highest time priority. It should be appreciated that user 2's order is not executed against user 3's order, which has the highest time priority.

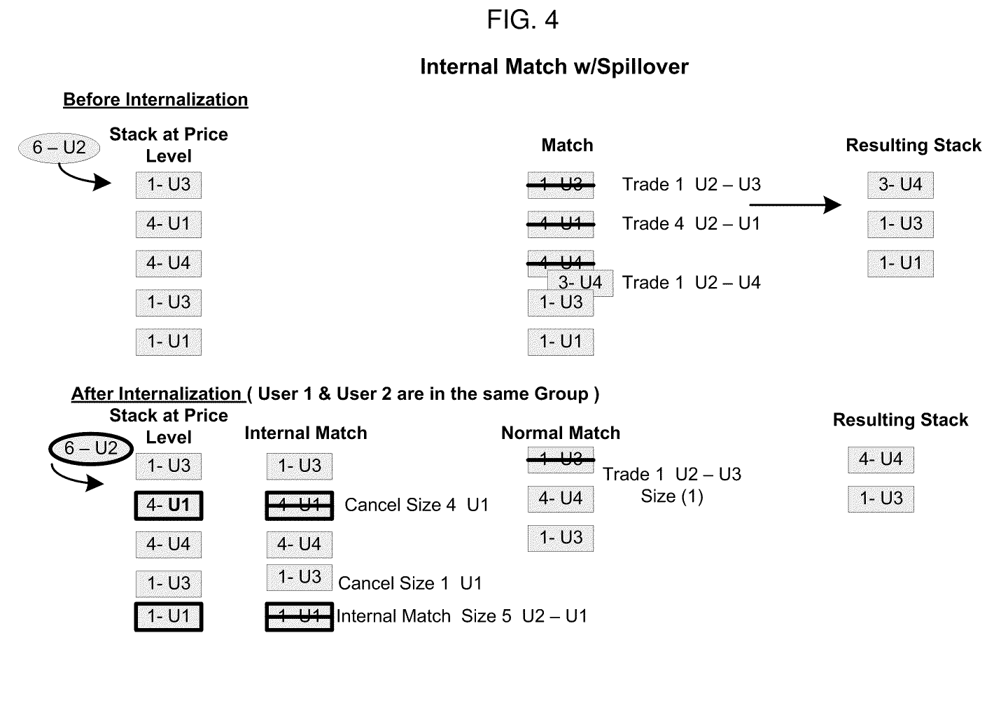

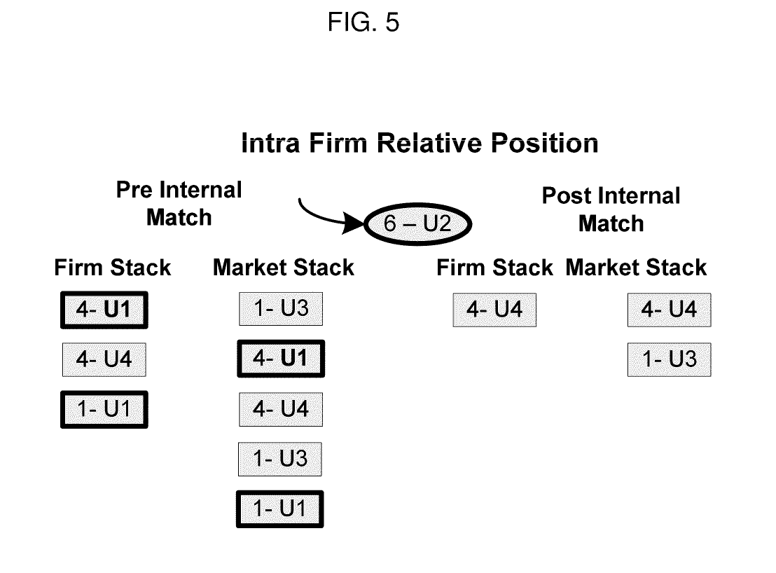

The top portion of FIG. 4 shows a matching according to traditional time priority rules. The bottom shows matching when user 2 and user 1 are “matched internally” first (e.g., because they are associated with the same entity). User 2's order is executed first against user 1's highest priority order and lower priority order before it is then executed against remaining orders (that are not “internal matches”) in order of time priority.

FIG. 5 shows an intra firm relative position, as further described herein.

Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the claims herein.

The following patents and patent applications are hereby incorporated by reference herein: U.S. Ser. No. 10/767,649 to Daley et al. (Attorney Docket No. 04-6176); U.S. Pat. No. 5,905,974 to Fraser et al; U.S. Ser. No. 09/745,651 by Claus et al. (Attorney Docket No. 99-1013), including the trading interfaces described therein; U.S. Pat. No. 7,155,410 to Kirwin et al. (Attorney Docket No. 99-1005); and U.S. Pat. No. 7,523,064 to Burns et al. The features described in these applications, e.g., features concerning orders and order specifications and display, matching capabilities, user interfaces, and other features, may also be implemented in the system described herein, and/or adapted for use with the systems and methods described herein.

1. An apparatus, comprising:
at least one processor; and
at least one memory that stores instructions which, when executed by the processor, direct the at least one processor to perform a method comprising:
receiving a first trading order from a first trading participant associated in the at least one database with a first entity, the first trading order comprising a price;
after receiving the first trading order, receiving a second trading order from a second trading participant associated in the at least one memory with a second entity different from the first entity, the second trading order comprising the price;
ordering the first trading order ahead of the second trading order in a trading order queue at the price;
after receiving the first and second trading orders and while the first trading order is available for execution, receiving a third trading order from a third trading participant associated with the second entity in the at least one memory, the third trading order being contra to the first and second trading orders at the same price;
determining that the second and third trading orders are associated with the same entity in the database;
based at least in part on determining that the second and third trading orders are associated with the same entity, matching at least a portion of the second trading order with at least a portion of the third trading order; and
causing the at least portion of the second trading order to be executed against the at least portion of the third trading order.

2. The apparatus of claim 1, in which the price comprises a best price in the market.

3. The apparatus of claim 1, in which the first order comprises a bid to purchase a first quantity of a financial instrument at the price, the second order comprises a bid to purchase a second quantity of a financial instrument at the price, and the third order comprises a hit, the hit comprising an order to execute a transaction against at least a portion of bid quantity available at the price.

4. The apparatus of claim 1, in which the first order comprises an offer to sell a first quantity of a financial instrument at the price, the second order comprises an offer sell a second quantity of a financial instrument at the price, and the third order comprises a take, the take comprising an order to execute a transaction against at least a portion of offer quantity available at the price.

5. The apparatus of claim 1, in which the method further comprises:
receiving a fourth trading order from a fourth trading participant associated with a third entity that is not associated with the first or second entities in the at least one memory, the fourth trading order being contra to at least an available portion of the first trading order and at least an available portion of the second trading order at the same price;
determining that the fourth trading order is contra to the first and second trading orders; and
matching at least a portion of the fourth trading order with at least a portion of the first trading order before any matching of any portion of the fourth trading order with any portion of the second trading order.

6. The apparatus of claim 1, in which the method further comprises:
causing the first and second orders to be ordered in a trading queue according to a time priority.

7. The apparatus of claim 1, in which the at least portion of the second trading order comprises all of the quantity of the second trading order.

8. The apparatus of claim 1, in which the at least portion of the third trading order comprises all of the quantity of the third trading order.

9. The apparatus of claim 1, in which the act of determining that the second and third trading orders are associated with the same entity in the database comprises:
determining an order identifier associated with the second order.

10. The apparatus of claim 1, in which the method further comprises:
causing the executed portion of the second trading order and the executed portion of the third trading order to be removed from the trading order queue; and
sending a message to a plurality of traders that the executed portion of the second trading order was cancelled.

11. The apparatus of claim 1, in which the method further comprises:
causing the executed portion of the second trading order and the executed portion of the third trading order to be removed from the trading order queue; and
sending a message to a plurality of traders that the executed portion of the second trading order was executed at the price.

12. The apparatus of claim 1, in which the method further comprises:
causing the executed portion of the second trading order and the executed portion of the third trading order to be removed from the trading order queue;
after causing the executed portion of the second trading order and the executed portion of the third trading order to be removed from the trading order queue, determining that a condition has been satisfied; and
based on determining that the condition has been satisfied, sending a message to a plurality of traders that the executed portion of the second trading order was executed at the price.

13. The apparatus of claim 1, in which the act of determining that the condition has been satisfied comprises:
determining that a predetermined period of time has passed after causing the at least portion of the second trading order to be executed against the at least portion of the third trading order.

14. The apparatus of claim 1, in which the act of determining that the condition has been satisfied comprises:
determining that a the financial instrument has been executed at a new price that is different from the price after causing the at least portion of the second trading order to be executed against the at least portion of the third trading order.

15. The apparatus of claim 1, in which the act of ordering the first trading order ahead of the second trading order in a trading order queue at the price comprises:
determining, for each of the first and second trading orders, a priority in a trading order queue based on a time at which each order was received.

16-29. (canceled)

30. A method comprising:
receiving a first trading order from a first trading participant associated in the at least one database with a first entity, the first trading order comprising a price;
after receiving the first trading order, receiving a second trading order from a second trading participant associated in the at least one memory with a second entity different from the first entity, the second trading order comprising the price;
ordering the first trading order ahead of the second trading order in a trading order queue at the price;
after receiving the first and second trading orders and while the first trading order is available for execution, receiving a third trading order from a third trading participant associated with the second entity in the at least one memory, the third trading order being contra to the first and second trading orders at the same price;
determining that the second and third trading orders are associated with the same entity in the database;
based at least in part on determining that the second and third trading orders are associated with the same entity, matching at least a portion of the second trading order with at least a portion of the third trading order; and
causing the at least portion of the second trading order to be executed against the at least portion of the third trading order.
